(19) United States
(12) Patent Application Publication
(10) Pub. No.: US 2009/0160171 A1
(43) Pub. Date: Jun. 25, 2009

(54) LOW RISK DEPLOYMENT DRIVER AIRBAG SYSTEM

(75) Inventors: Jong Seop Nam, Commerce Township, MI (US); Seung-Jae Song, Novi, MI (US)

Correspondence Address: GIFFORD, KRASS, SPRINKLE,ANDERSON & CITKOWSKI, P.C, PO BOX 7021, TROY, MI, 48007-7021, US

(73) Assignee: CIS Tech, LLC, Novi, MI (US)

(21) Appl. No.: 12/052,869

(22) Filed: Mar. 21, 2008

Related U.S. Application Data
(60) Provisional application No. 61/015,969, filed on Dec. 21, 2007.
(60) Provisional application No. 61/022,972, filed on Jan. 23, 2008.

(51) Int. Cl. B60R 21/16

(52) U.S. Cl. 280/743.2

(57) ABSTRACT

A driver airbag includes a front panel facing a driver and an opposite rear panel. Each panel has a central region and a perimeter with a center point being defined at the geometric center of the panel. The perimeters of the front and rear panels are joined to provide an airbag outer shell. A lower tether has a first end secured to the central region of the front panel and a second end being secured to the central region of the rear panel. An upper tether or membrane has a perimeter that is secured to the front and rear panels above the center points thereof. A lower chamber is defined by and below the upper tether and an upper chamber is defined by and above the upper tether. The upper tether has an opening defined therethru for gas to flow from the lower chamber to the upper chamber.

### REFERENCE TO RELATED APPLICATIONS

This application claims priority from U.S. Provisional Patent Application Ser. No. 61/059,969, filed Dec. 21, 2007 and U.S. Provisional Patent Application Ser. No. 61/072,972, filed Jan. 23, 2008, the entire content of both of which are incorporated herein by reference.

### FIELD OF THE INVENTION

This invention relates to a driver airbag system for use with a motor vehicle, wherein airbag tethers are designed in such a way as to minimize the risk of injuries caused by airbag inflation to an out-of-position occupant while improving in-position occupant protection during serious crashes.

### BACKGROUND OF THE INVENTION

A dual stage inflator is being used in many passenger vehicles in which the vehicle is required to pass a government's low risk deployment advanced airbag rule. The dual stage inflator is made of two chambers and typically generates two levels of inflator output depending on the severity of crashes. This advanced airbag rule has reduced the risk of injuries caused by the airbag inflation to out-of-position occupants. However, the cost of the dual stage inflator is much higher than single stage inflators. It also has increased the development cost to car makers by requiring an increased number of tests and more complicated airbag deployment algorithms.

The objective of the present invention is therefore to design a driver airbag that may use a lower cost single stage inflator and still meet the low risk deployment advanced airbag rule as well as other regulations and due care requirements related to high speed crashes.

### SUMMARY OF THE INVENTION

The conventional driver airbag system has a dual stage inflator, a circular front panel facing a driver, a circular rear panel opposite to the front panel with a hole to allow a disk type inflator to be inserted, and a tether located around the center areas of the front and rear panels. The main function of the conventional tether is to control the shape of the airbag during the inflation. The tether restricts the excessive movement of the airbag toward the occupant and therefore helps the airbag deploy in a radial direction, which is safer for an in-position occupant during the inflation and effective for occupant protection during cushioning. The tether sometimes can provide an additional function to control the gas flow inside the airbag to improve the airbag kinematics during the inflation.

The driver airbag system of the present invention is an improvement of the conventional driver airbag and may function with a single stage inflator whose output is comparative to the low output of a typical dual stage inflator. A typical high output of a dual stage inflator is about 200 kPa and its typical low output is 70% of the high output or 140 kPa. In this case, the single stage inflator to be used in the present invention will be about 140 kPa. In one embodiment, the driver airbag includes a front panel facing a driver and an opposite rear panel. Each panel has a central region and a perimeter with a center point being defined within the central region at the geometric center of the panel. The perimeters of the front and rear panels are joined so as to provide an airbag outer shell. A lower tether has first and second ends, with the first end being secured to the central region of the front panel and the second end being secured to the central region of the rear panel. An upper tether or membrane has a perimeter, and is secured along its perimeter to the front panel and the rear panel above the center points thereof. A lower chamber is defined by and below the upper tether and an upper chamber is defined by and above the upper tether. The upper tether has an opening defined therethru for gas to flow from the lower chamber to the upper chamber.

The main function of the lower tether is to control the shape of the airbag during the inflation. The exemplary embodiments are shown in the accompanying drawings. The main function of the upper tether is to control the shape of the airbag during inflation and also control the gas flow inside the airbag during the airbag inflation and during the airbag cushioning when it is loaded by the occupant's body parts.

The front and rear panels may both be generally circular and the upper tether may have an elliptical shape similar to a cross sectional view of a fully inflated driver airbag. One half of the upper tether perimeter may be secured, such as by stitching, to the upper part of the front panel in a two-dimensional flat layout, and the other half of the upper tether perimeter may be secured, such as by stitching, to the upper part of the rear panel in a two-dimensional flat layout, as shown in the drawings. In preferred embodiments, the upper tether is secured to the front panel at a position at least 5 centimeters above the center point of the front panel and the upper tether is secured to the rear panel at a position at least 5 centimeters above the center point of the rear panel. Also in preferred embodiments, the lower tether may be secured to the front panel below the center point of the front panel and the lower tether is secured to the rear panel below the center point of the rear panel.

The upper tether divides the airbag into two chambers, a lower chamber as a primary chamber and an upper chamber as a secondary chamber. Seen from the side view of a fully inflated airbag, the upper tether may be disposed substantially perpendicular to the front and rear panels. The occupant loading direction into the primary chamber is substantially perpendicular to the front panel during a belted dynamic test. The preferred volume ratio between the primary lower chamber and the secondary upper chamber is somewhere between 60:40 and 90:10. In other words, the lower chamber preferably has 60% to 90% of the total airbag volume, though other percentages are possible depending on the application. The most preferred ratio is approximately 70:30 in which the lower chamber has approximately 70% of the total airbag volume. This 70% corresponds to the typical low output of a dual stage inflator, and is the output of the single stage inflator that may be used in the present invention. The upper tether has one or more openings defined therethru to control the flow of gas from the lower chamber to the upper chamber during inflation and during cushioning. The preferred total size of the opening area ranges from 10 to 40 square centimeters (cm²). In some preferred embodiments, the upper tether is disposed generally horizontal in a front view of the airbag when the airbag is inflated. In other preferred embodiments, the upper tether is disposed in a generally upside down U or V shape in a front view of the airbag when the airbag is inflated. As mentioned above, the upper tether may have an elliptical shape. Alternatively, it may generally have a peanut shape or a rectangular shape with or without rounded corners, as well as other shapes.

During a static airbag deployment test in which a vehicle is stationary and no occupant is involved, the inflator generates a gas, the gas flows into the primary lower chamber, an airbag door is opened by the pressure built up in an airbag housing, the lower chamber inflates to its full volume, the gas flows into the upper chamber through the internal opening or vent holes located at the upper tether, and finally the upper chamber inflates to its full volume. The full inflation time of the airbag of the present invention including the upper chamber becomes longer than that of the conventional airbag due to the restriction of the gas flow through the opening or internal vents. The amount of time delay depends on the size of the opening. The preferred time delay is about 10 msec to 20 msec (millisecond).

During an out-of-position test in which an airbag is deployed with a 5th percentile female dummy leaned against a steering wheel, the airbag of the present invention will tend to deploy downward first toward a chest area of the dummy followed by the upward deployment toward the head and neck area of the dummy with a substantial delay in time between the downward and the upward deployments. This delay can substantially help to reduce the risk of serious neck injuries, with the neck typically being the most vulnerable area in meeting the regulations.

During a belted dynamic test in which the occupant's torso and head motion is forward, downward, and rotational at the same time, the head of an occupant contacts the center area of the front panel which is a part of the primary lower chamber and continues to push the airbag perpendicularly toward the center area of the rear panel which is also part of the primary lower chamber. During this cushioning event, the gas in the primary lower chamber is forced to flow into the secondary upper chamber through the opening or internal vents and absorbs the kinetic energy of the occupant's head. In this belted test, the torso is mostly restrained by the belt and the head is mostly restrained by the primary lower chamber.

During an unbelted dynamic test in which the occupant motion is substantially forward in a horizontal direction, the torso of an occupant contacts the lower part of the primary lower chamber and continues to push the airbag in the forward horizontal direction and forces the gas in the primary lower chamber to flow into the secondary upper chamber and absorbs the torso's kinetic energy. The head of the occupant, initially located farther away from the airbag than the torso, contacts the center area of the front panel later than the torso contacts the airbag and continues to move forward horizontally toward the secondary upper chamber. By the time the head moves to the secondary upper chamber, the upper chamber is fully inflated by the additional action of the torso squeezing the lower chamber and thus absorbs the kinetic energy of the occupant's head. The upper chamber may or may not have vent holes that can externally vent the gas from the upper chamber to the outside of the airbag. In this unbelted test, the torso is mostly restrained by the primary lower chamber and the head is mostly restrained by the secondary upper chamber.

The output of conventional inflators may be reduced significantly due to the benefits of embodiments of the present invention. It is estimated, for example, that the inflator output can be reduced by 30% or more if the secondary upper chamber has 30% of the total volume because the inflator needs to initially inflate only the lower chamber having 70% of the total volume. In other words, the conventional dual stage inflator may be replaced by a single stage inflator that has about 70% of the high output level, which is typically the low output level of the dual stage inflator. The use of low output single stage inflators along with the present invention can not only save cost for the vehicles but also can improve the performance of occupant protection by inflating the airbag at its full pressure equivalent to the high pressure level generated by the high output of the dual stage inflator no matter how severe the crash is and no matter what size of occupant is involved.

### BRIEF DESCRIPTION OF THE DRAWINGS

Advantages of the present invention will be readily appreciated as the same becomes better understood by reference to the following description when considered in connection with the accompanying drawings, wherein:

FIG. 1 shows a front panel of a conventional driver airbag in which a tether having multiple straps is secured around the central region of the front panel;

FIG. 2 shows a rear panel of the conventional driver airbag in which the other ends of the tether are secured around the central region of the rear panel;

FIG. 3 shows a front view and a side view of the conventional driver airbag after inflation;

FIG. 4 shows a front panel of an embodiment of the present invention in which a lower tether having multiple straps is secured around the central region of the front panel and an upper tether having an elliptical shape is secured along the one half perimeter above the center point of the front panel in a two dimensional flat layout;

FIG. 5 shows a rear panel of the embodiment of the present invention in which the other ends of the lower tether are secured around the central region of the rear panel and the upper tether is secured along the other half perimeter above the center point in a two dimensional flat layout;

FIG. 6 shows a front view and a side view of the embodiment of the present invention after being fully inflated in which the upper tether is located approximately one third below the top of the airbag, curves slightly upward at the ends in the front view, and is substantially perpendicular to the front and rear panels in the side view;

FIG. 7 shows an out-of-position test in which an embodiment of the present invention is being deployed with a 5th percentile female dummy leaned against a steering wheel;

FIG. 8 shows a dynamic test with an in-position occupant in which the dummy kinematics is shown by arrows with solid lines indicating a belted test and dotted lines indicating an unbelted test;

FIG. 9 shows a belted dynamic test with an in-position occupant in which the dummy loading area into the airbag is shown;

FIG. 10 shows an unbelted dynamic test with an in-position occupant in which the dummy loading area into the airbag is shown;

FIG. 11 shows a front panel of a second embodiment of the present invention in which a lower tether having multiple straps is secured around the central region and an upper tether having an elliptical shape is secured along the one half perimeter above the center point in a two dimensional flat layout;

FIG. 12 shows a rear panel of the second embodiment of the present invention in which the other ends of the lower tether are secured around the central region and the upper tether is secured along the other half perimeter above the center point in a two dimensional flat layout;

FIG. 13 shows a front view and a side view of the second embodiment of the present invention after being fully inflated in which the upper tether is located approximately one third below the top of the airbag, curves slightly downward at the ends in the front view, and is substantially perpendicular to the front and rear panels in the side view;

FIG. 14 shows a plan view of a third embodiment of the present invention in which the upper and lower portions of the upper tether perimeter shown in FIGS. 4 and 5 run straight all the way to the perimeters of the airbag panels;

FIG. 15 shows a plan view of a fourth embodiment of the present invention in which the upper and lower portions of the upper tether perimeter shown in FIGS. 11 and 12 run straight all the way to the perimeters of the airbag panels;

FIG. 16 shows possible variations of the present invention in which an upper tether has a variety of shapes;

FIG. 17 shows a front panel of a fifth embodiment of the present invention in which a lower tether has only one strap and is secured around the central region;

FIG. 18 shows a front panel of a sixth embodiment of the present invention in which a lower tether has two straps with a trapezoidal sewing seam;

FIG. 19 shows a front panel of a seventh embodiment of the present invention in which a lower tether has a straight strap with a rectangular sewing seam;

FIG. 20 shows a front panel of an eighth embodiment of the present invention in which a lower tether has three straps with a circular sewing seam;

FIG. 21 shows a front view and a side view of a ninth embodiment of the present invention after being fully inflated in which the upper tether is located approximately one third below the top of the airbag, runs generally straight horizontally without curving at the ends, and is substantially perpendicular to the front and rear panels;

FIG. 22 shows a tenth embodiment of the present invention after being fully inflated in which the upper tether curves downward to give a generally upside down U shape, thereby maximizing the height of the primary lower chamber in the central region;

FIG. 23 shows an eleventh embodiment of the present invention after being fully inflated in which the upper tether has a shape similar to an upside down U or V; and

FIG. 24 shows additional embodiments of the present invention after being fully inflated in which the airbag has only an upper tether.

### DETAILED DESCRIPTION OF THE INVENTION

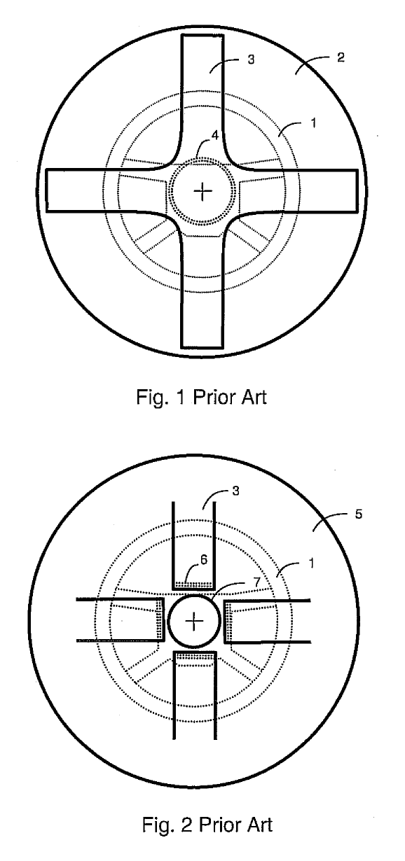

FIG. 1 shows a front panel 2 of a conventional driver airbag with a tether 3 having four straps placed in a two dimensional flat layout and stitched around the central region 4. The diameter of the front panel 2 is substantially larger than a steering wheel 1 as it shrinks during the inflation and still needs to cover the steering wheel.

FIG. 2 shows a rear panel 5 of the conventional driver airbag to which ends 6 of the four straps of the tether 3 is stitched around an inflator hole 7 through which a disk type inflator is inserted.

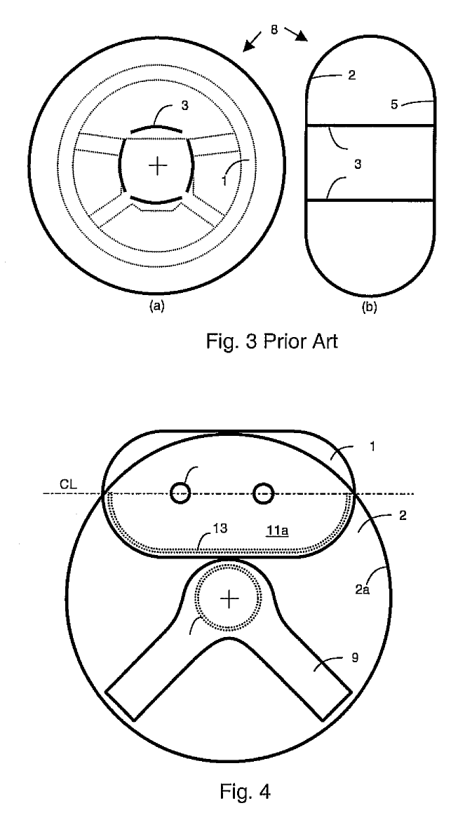

FIG. 3 shows an inflated conventional airbag 8 which is a combination of the front panel shown in FIG. 1 and the rear panel shown in FIG. 2. The two circular panels are stitched together along their perimeters. The diameter of the inflated airbag 8 is slightly larger than that of the steering wheel 1. The tether 3 is substantially perpendicular to the front panel 2 and rear panel 5 in a side view. The main function of the tether 3 is to control the shape of the airbag 8 during inflation without substantially restricting gas flow inside the airbag. This tether helps the airbag to inflate in a radial direction by keeping the distance between the two panels at a certain amount.

FIG. 4 shows a circular front panel 2 of a first embodiment of the present invention. A lower tether 9 has two straps and is secured, typically by stitching, around the central region 10. An upper tether 11 has a first portion or half 11a, the perimeter 13 of which is secured, typically by stitching, to the front panel 2 above a center point C of the panel 2. The lower tether may be secured to the front panel below the center point C in order to balance with the upper tether. All the stitching is preferably done on a two dimensional flat layout as shown in the figure. For definitional purposes, the front panel may be said to have the center point C at its geometric center and the central region 10 surrounding the center point C. The perimeter 2a of the front panel in this embodiment is equidistant from the center point C, since the front panel is circular. The front panel and corresponding back panel may have other shapes, though circular is typical.

Preferably, a center line CL of the upper tether 11 intersects the perimeter 2a of the front panel 2. As shown, the perimeter 13 of the first portion or half 11a is preferably secured to the front panel substantially above the center point C of the front panel 2. In some embodiments, the distance between the center point C and the position where the upper tether 11 is secured to the front panel 2 (at the perimeter 13) is at least 5 centimeters, while in further embodiments the distance is at least 8 centimeters. In this embodiment, the shape of the upper tether 11 is generally elliptical and resembles a cross sectional view of an inflated driver airbag. The upper tether has an opening, in the form of holes 12, defined therethru that is sufficiently small to restrict the flow of gas therethru. The preferred total size of the opening area ranges from 10 to 40 square centimeters (cm²). The holes may not be necessary if there is a significant amount of leakage through loose stitching or missed stitching area at the intersections. Therefore the total opening area should include any type of opening between the lower chamber and the upper chamber.

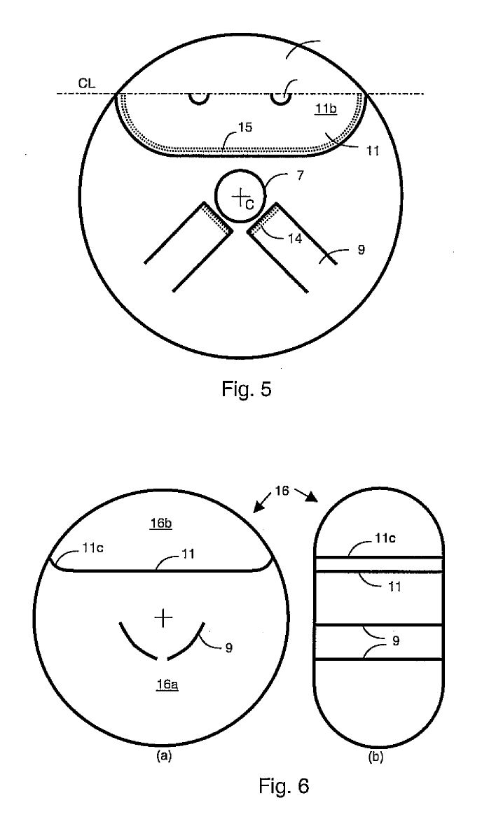

FIG. 5 shows a circular rear panel 5 of the first embodiment of the present invention. The other ends 14 of the lower tether 9 are secured to the central region around the inflator hole 7. The inflator hole is typically located slightly below the geometrical center of the rear panel (typically one inch below) as the inflator is located slightly below the steering wheel center. The second portion or half 11b of the upper tether 11 is secured to the rear panel 5 along the perimeter 15 at a position substantially above the center point C. In some embodiments, the distance between the center point C and the position where the upper tether I1 is secured to the rear panel 5 (at the perimeter 15) is at least 5 centimeters, while in further embodiments the distance is at least 8 centimeters. The lower tether may be secured to the rear panel below the center point C in order to balance with the upper tether. In some embodiments, however, the lower tether may be secured around the central regions. In some embodiments, the lower tether is secured to the front and/or rear panels below the center point C and generally towards the lower side of the airbag. This places most or all of the straps of the lower tether 9 below the center point C. All the stitching is preferably done on a two dimensional flat layout as shown in the figure.

It is preferred that the second portion of the upper tether 11b shown in FIG. 5 is symmetric to the first portion of the upper tether 11a shown in FIG. 4 in this embodiment. However, the two portions can be designed asymmetric in order to make some variations to the tether alignment, chamber size, airbag shape, or other characteristics of an inflated airbag.

FIG. 6 shows front and side views of an inflated driver airbag 16 according to the first embodiment of the present invention after the perimeters of the front panel 2 and the rear panel 5 are joined together to form an airbag outer shell. The lower tether 9 is secured around the central regions of the front and rear panels. The upper tether 11 is disposed generally horizontally in a front view (a) and may curve slightly upward at the ends 11c as the width of the upper tether is restricted as the airbag inflates. The upper tether is disposed substantially perpendicular to the front and rear panels as shown in a side view (b) when the airbag is inflated. The lower tether 9 controls the shape of the airbag during inflation to make it elliptical in a side view (b) by keeping the distance between the two panels at a certain distance. The upper tether 11 divides the airbag 16 into a lower chamber 16a and an upper chamber 16b. Preferably, the entirety of the perimeter 13, 15 is secured to the front and back panels such that the only opening between the chambers is thru the holes 12. The lower chamber 16a includes the central regions of the front and rear panels, and therefore is substantially larger in volume than the upper chamber 16b. The gas generated from an inflator inflates the lower chamber 16a first and flows into the upper chamber 16b through the opening 12 and eventually inflates the upper chamber to its full volume.

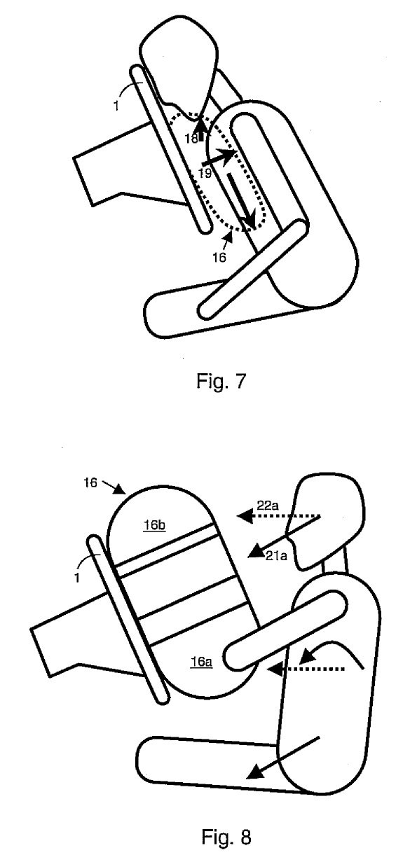

FIG. 7 shows an out-of-position (OOP) test in which an airbag 16 according to the present invention is deployed with a 5th percentile female dummy 17 placed against a steering wheel 1. Due to the restriction of the gas flow from the lower chamber to the upper chamber explained in FIG. 6, the airbag 16 deploys substantially downwards 20 generating a force 19 toward a chest area of the dummy 17. The upward force 18 which is typically as large as the force 20 in a conventional airbag is now substantially smaller than the force 20 in this driver airbag of the present invention. The neck is typically the most vulnerable body part of the dummy in meeting the OOP injury criteria.

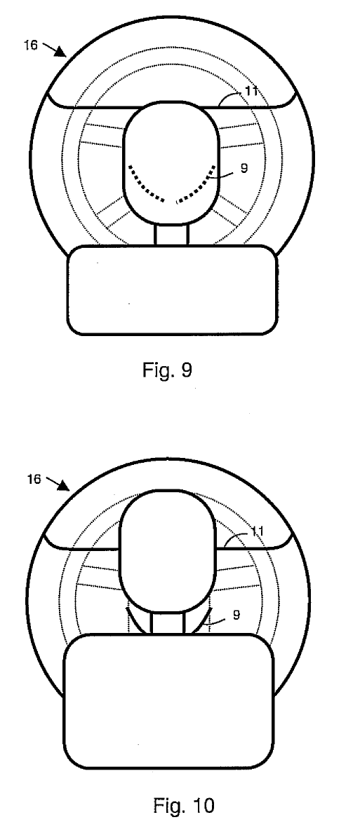

FIG. 8 shows dummy kinematics in a high speed dynamic test. A belted dummy 17 tends to move forward and downward as depicted by arrows 21a, 21c and rotates counterclockwise as depicted by an arrow 21b. Due to the downward motion and the rotation, the head of the in-position dummy contacts the central region of the front panel and continues to move toward the center of the rear panel as shown in FIG. 9. In other words, the head pushes into the primary lower chamber substantially perpendicular to the airbag panels. This action increases the pressure inside the lower chamber and forces the gas to vent through the opening or internal vents located at the upper tether into the upper chamber, thereby absorbing the kinetic energy of the head.

On the other hand, an unbelted dummy 17 tends to move forward substantially horizontally as depicted by dotted lines 22a, 22b in FIG. 8. The torso makes a first contact with the lower chamber 16a and continues to push the airbag and increases the pressure inside the lower chamber. This forces the gas to vent through the opening or internal vents located in the upper tether and inflates the upper chamber more quickly. The head contacts the airbag slightly above the central region at a later time compared to the torso's initial contact due to the fact that the head is located farther away from the airbag. By the time the head contacts the airbag and continues to move towards the upper chamber as shown in FIG. 10, the upper chamber is fully inflated by the aid of the squeezing action of the torso pushing the lower chamber.

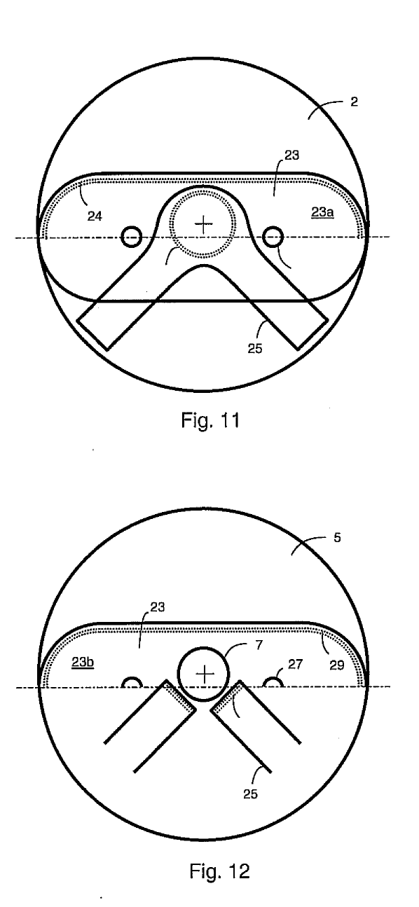

FIG. 11 shows a front panel 2 of a second embodiment of an airbag according to the present invention. In this embodiment, a lower tether 25 has two straps that are stitched around the central region 26 of the front panel. A first portion or half 23a of an upper tether 23 is stitched along its perimeter 24 to the front panel 2 substantially above the center point C. All the stitching is preferably done on a two dimensional flat layout as shown in the figure.

FIG. 12 shows a rear panel 5 of the second embodiment of the present invention to which the second portion or half 23b of the upper tether 23 is stitched along its perimeter 29 to the rear panel above the inflator hole 7 of the rear panel 5. All the stitching is preferably done on a two dimensional flat layout as shown in the figure.

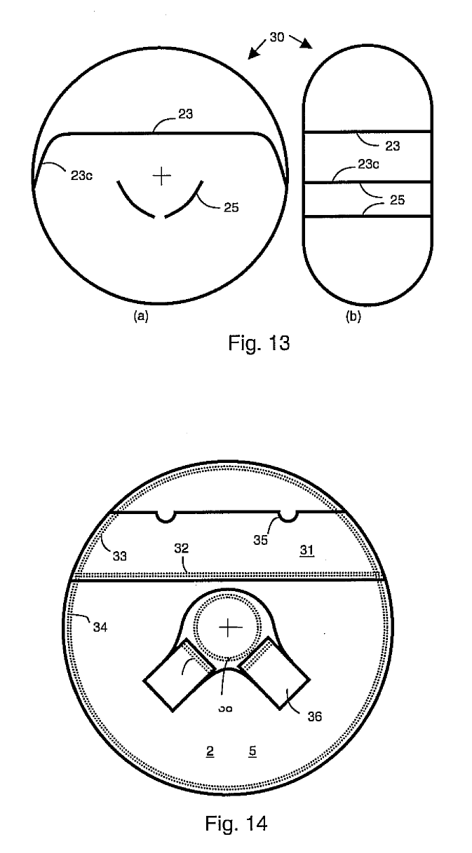

FIG. 13 shows an inflated airbag of the second embodiment of the present invention after the front panel shown in FIG. 11 and the rear panel shown in FIG. 12 are stitched together along their perimeters The upper tether 23 is disposed substantially horizontal in a front view (a) and may curve downward at the ends 23c as the width of the upper tether is restricted when the airbag inflates. The benefit of this embodiment of the present invention is basically the same as the one explained in FIG. 6.

FIG. 14 shows a plan view (front or rear) of a third embodiment of the present invention after all necessary parts are stitched. This is a slight variation of the first embodiment of the present invention shown in FIGS. 4 and 5. The upper and lower perimeters 32 of the upper tether 31 run straight all the way to the perimeters 34 of the airbag front and rear panels 2 and 5. The upper perimeter 32 of the upper tether 31 is secured to the front panel 2 and the lower perimeter 32 of the upper tether 31 is secured to the rear panel 5. The side perimeters 33 of the upper tether 31 are stitched together with the front and rear panel perimeters 34 so that a total of four layers are stitched together. One end of a lower tether 36 is secured to the airbag front panel 2 around the central region 38 and the other end 37 of the lower tether 36 is secured to the airbag rear panel 5. All the stitching is preferably done on a two dimensional flat layout as shown in the figure.

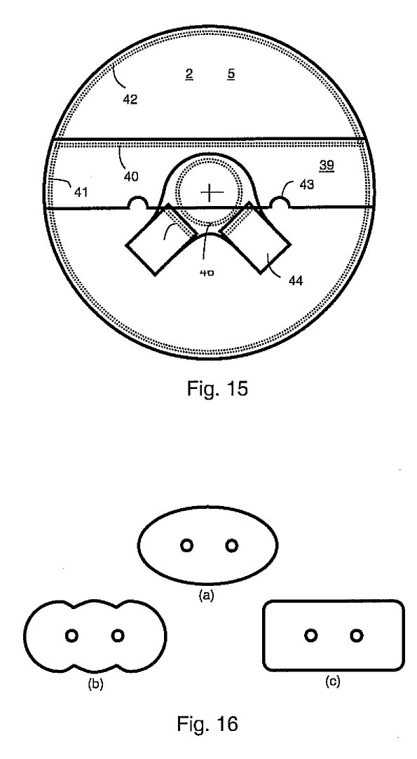

FIG. 15 shows a plan view (front or rear) of a fourth embodiment of the present invention after all necessary parts are stitched. This is a slight variation of the second embodiment of the present invention shown in FIGS. 11 and 12. The upper and lower perimeters 40 of the upper tether 39 run straight all the way to the perimeters 42 of the airbag front and rear panels 2 and 5. The upper perimeter 40 of the upper tether 39 is secured to the front panel 2 and the lower perimeter 40 of the upper tether 3 9 is secured to the rear panel 5. The side perimeters 41 of the upper tether 39 are stitched together with the front and rear panel perimeters 42 so that a total of four layers are stitched together. One end of a lower tether 44 is secured to the airbag front panel 2 around the central region 46 and the other end 45 of the lower tether 44 is secured to the airbag rear panel 5. All the stitching is preferably done on a two dimensional flat layout as shown in the figure.

FIG. 16 shows a variety of the upper tether shapes in plan view. FIG. 16(a) is a perfect ellipse. FIG. 16(b) is a peanut shape variation. FIG. 16(c) is generally rectangular with or without rounded corners.

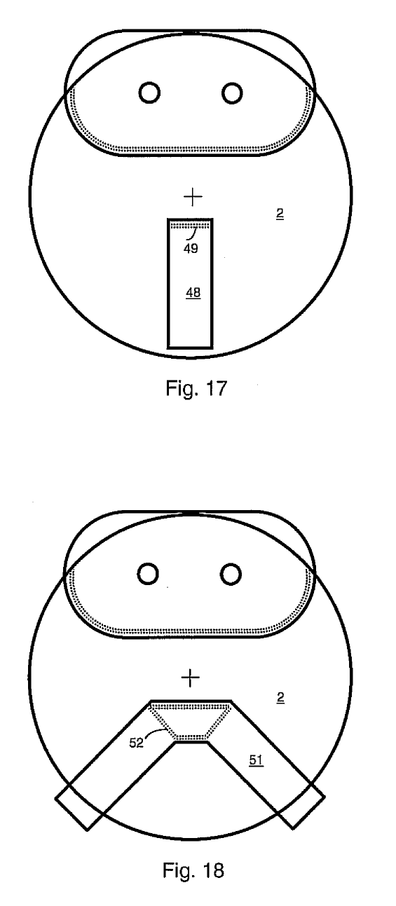

FIG. 17 shows a front panel 2 of a fifth embodiment of the present invention to which a one strap lower tether 48 is secured below the center point of the front panel 2 with a straight stitching seam 49. An upper tether 47 similar to FIG. 4 is also shown. The stitching of the lower tether can be done around the central region as a variation.

FIG. 18 shows a front panel 2 of a sixth embodiment of the present invention to which a two strap lower tether 51 is secured below the center point of the front panel 2 with a trapezoidal stitching seam 52. An upper tether 50 similar to FIG. 4 is also shown. The stitching of the lower tether can be done around the central region as a variation.

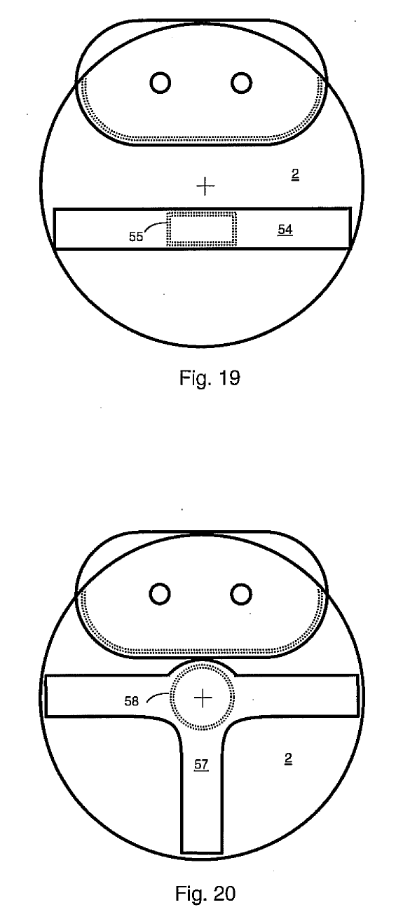

FIG. 19 shows a front panel 2 of a seventh embodiment of the present invention to which a two strap lower tether 54 is secured below the center point of the front panel 2 with a rectangular stitching seam 55. An upper tether 53 similar to FIG. 4 is also shown. The stitching of the lower tether can be done around the central region as a variation.

FIG. 20 shows a front panel 2 of an eighth embodiment of the present invention to which a three strap lower tether 57 is secured around the central region of the front panel 2 with a circular stitching seam 58. An upper tether 56 similar to FIG. 4 is also shown. The stitching of the lower tether can be done around the central region as a variation.

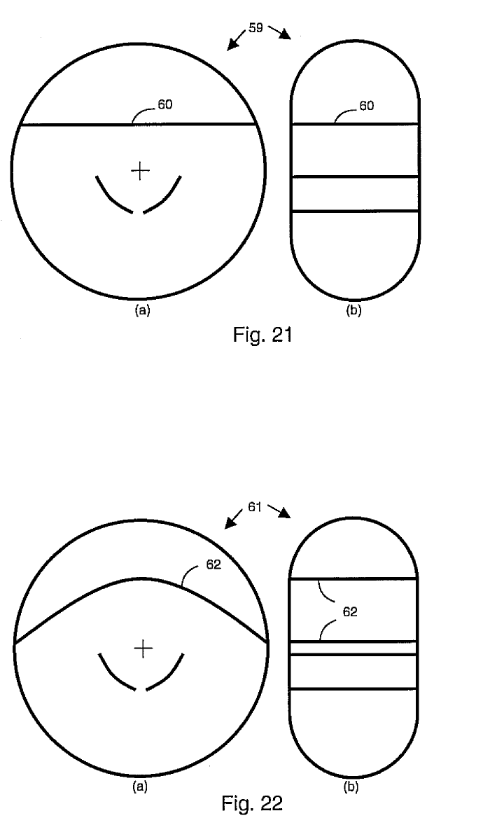

FIG. 21 shows an inflated airbag 59 of a ninth embodiment of the present invention in which the upper tether 60 is disposed substantially straight in the front view (a) without curving at the ends. This straight line of the upper tether can be achieved if the shape of the upper tether is optimized or the stitching seam is chosen with a three dimensional figure in mind.

FIG. 22 shows an inflated airbag 61 of a tenth embodiment of the present invention in which the upper tether 62 is curved or arced in the front view (a). This shape may be described as being generally shaped like an upside down U. The tether 62 may also be said to be curved with a concave side directed toward the central region. This embodiment maximizes the central region of the primary lower chamber while keeping the volume ratio between the two chambers approximately the same.

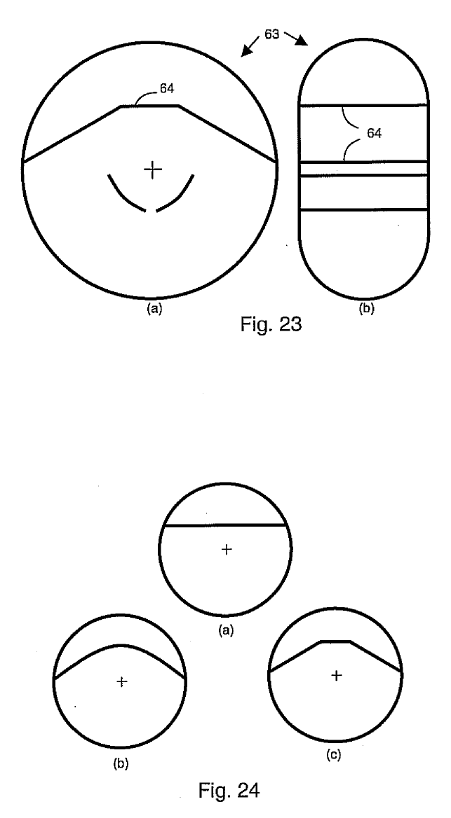

FIG. 23 shows an inflated airbag 63 of an eleventh embodiment of the present invention in which the upper tether 64 has three straight sections that are angled to again provide a concave side of the tether directed toward the central region. This shape may also be described as being generally shaped like an upside down U or V. The benefit of this embodiment is similar to that of FIG. 22.

FIG. 24 shows inflated airbags (a), (b), and (c) of additional embodiments of the present invention in which the airbags have only upper tethers. The lower tether may not be necessary if the upper tether is located close to the geometrical center of the front and rear panels. It is, however, recommended that both upper and lower tethers should be used to have a balanced airbag inflation. Any of the details or variations discussed above with respect to earlier embodiments may also be applied to the embodiments of FIG. 24.

As shown in various figures, preferred embodiments of the present invention provide an airbag cushion or shell that, when inflated, has a front panel and rear panel that are generally parallel to each other, at least in areas. This is in contrast to a more spherical shape an airbag cushion would form is not restrained by the upper and/or lower tethers.

As will be clear to those of skill in the art, the herein-described embodiments of the present invention may be altered in various ways without departing from the scope or teaching of the present invention. It is the following claims, including all equivalents, which define the scope of the invention.

We claim:

1. A driver airbag for installation in a steering wheel of an automotive vehicle, the driver airbag comprising:
a front panel facing a driver, the front panel having a central region and a perimeter, a center point being defined within the central region at the geometric center of the front panel;
a rear panel opposite to the front panel, the rear panel having a central region and a perimeter, a center point being defined within the central region at the geometric center of the rear panel, the perimeters of the front and rear panels being joined so as to provide an airbag outer shell;
a lower tether having first and second ends, the first end being secured to the central region of the front panel and the second end being secured to the central region of the rear panel;
an upper tether having a perimeter, the upper tether being secured along its perimeter to the front panel and the rear panel above the center points thereof;
wherein a lower chamber is defined by and below the upper tether and an upper chamber is defined by and above the upper tether; and
the upper tether having an opening defined therethru for gas to flow from the lower chamber to the upper chamber.

2. The driver airbag according to claim 1, wherein the front and rear panels are each generally circular and the upper tether is generally elliptical.

3. The driver airbag according to claim 1, wherein the upper tether is disposed substantially perpendicular to the front and rear panels when the airbag is inflated with gas.

4. The driver airbag according to claim 1, wherein the upper tether is secured to the front panel at a position at least 5 centimeters above the center point of the front panel and the upper tether is secured to the rear panel at a position at least 5 centimeters above the center point of the rear panel.

5. The driver airbag according to claim 1, wherein the lower tether is secured to the front panel below the center point of the front panel and the lower tether is secured to the rear panel at a position below the center point of the rear panel.

6. The driver airbag according to claim 5, wherein the lower tether has one or more straps extending between the front and rear panels, most or all of the straps being below the center points of the front and rear panels.

7. The driver airbag according to claim 1, wherein the volume of the upper chamber is substantially smaller than the volume of the lower chamber.

8. The driver airbag according to claim 7, wherein the volume of the upper chamber is in the range of 10% to 40% of the total volume of the airbag when fully inflated.

9. The driver airbag according to claim 1, wherein the size of the opening defined thru the upper tether is sized to restrict the gas flow from the lower chamber to the upper chamber.

10. The driver airbag according to claim 9, wherein the size of the opening is in the range of from 10-40 square centimeters.

11. The driver airbag according to claim 1, wherein the upper tether has a first portion and a second portion, the first portion being stitched along its perimeter to the front panel in a two dimensional flat layout and the second portion being stitched along its perimeter to the rear panel in a two dimensional layout.

12. The driver airbag according to claim 1, wherein the upper tether has a first portion and a second portion, the first portion being stitched along its perimeter to the front panel and the second portion being stitched along its perimeter to the rear panel, the first portion and the second portion being generally symmetrical.

13. The driver airbag according to claim 1, wherein the upper tether is disposed generally horizontally in a front view of the airbag when the airbag is inflated.

14. The driver airbag according to claim 1, wherein the upper tether is disposed in a generally upside down U or V shape in a front view of the airbag when the airbag is inflated.

15. The driver airbag according to claim 1, wherein the upper tether is generally peanut shaped.

16. The driver airbag according to claim 1, wherein the upper tether has a generally rectangular shape with or without rounded corners.

17. The driver airbag according to claim 1, wherein the entirety of the perimeter of the upper tether is secured to the front panel and rear panels.

18. The driver airbag according to claim 1, wherein the opening defined thru the upper tether comprises 2 or more openings.

19. The driver airbag according to claim 1, wherein the lower tether comprises two straps each having a first end secured to the front panel and a second end secured to the rear panel.

20. The driver airbag according to claim 1, further comprising a single stage inflator.

21. The driver airbag according to claim 20, wherein the single stage inflator has an output in the range of 100 kpa to 160 kpa on a 60 L tank test.

22. A driver airbag for installation in a steering wheel of an automotive vehicle, the driver airbag comprising:
a front panel facing a driver, the front panel having a central region and a perimeter, a center point being defined within the central region at the geometric center of the front panel;
a rear panel opposite to the front panel, the rear panel having a central region and a perimeter, a center point being defined within the central region at the geometric center of the rear panel, the perimeters of the front and rear panels being joined so as to provide an airbag outer shell;
an upper tether having a first portion and a second portion each having a perimeter, the perimeter of the first portion being secured to the front panel above the center point thereof and the perimeter of the second portion being secured to the rear panel above the center point thereof,
wherein a lower chamber is defined by and below the upper tether and an upper chamber is defined by and above the upper tether; and
the upper tether having an opening defined therethrough for gas to flow from the lower chamber to the upper chamber.

23. The driver airbag according to claim 22, wherein at least a portion of the front panel is generally parallel to at least a portion of the rear panel when the airbag is inflated, the upper tether being generally perpendicular to the front and rear panel when the airbag is inflated.

24. The driver airbag according to claim 22, wherein the first portion of the upper tether is secured to the front panel in a two dimensional flat layout and the second portion of the upper tether is secured along its perimeter to the rear panel in a two dimensional layout.

25. The driver airbag according to claim 22, wherein the first and second portions of the upper tether are generally symmetrical.

26. The driver airbag according to claim 22, wherein the front and rear panels are each generally circular and the upper tether is generally elliptical.

27. The driver airbag according to claim 22, wherein the upper tether is secured to the front panel at a position at least 5 centimeters above the center point of the front panel and the upper tether is secured to the rear panel at a position at least 5 centimeters above the center point of the rear panel.

28. The driver airbag according to claim 22, wherein the upper tether is disposed generally horizontally in a front view of the airbag when the airbag is inflated.

29. The driver airbag according to claim 22, wherein the upper tether is disposed in a generally upside down U or V shape in a front view of the airbag when the airbag is inflated.

30. The driver airbag according to claim 22, wherein the upper tether is generally peanut shaped.

31. The driver airbag according to claim 22, wherein the upper tether has a generally rectangular shape with or without rounded corners.

32. The driver airbag according to claim 22, wherein the volume of the upper chamber is substantially smaller than the volume of the lower chamber.

33. The driver airbag according to claim 32, wherein the volume of the upper chamber is in the range of 10% to 40% of the total volume of the airbag when fully inflated.

34. The driver airbag according to claim 22, wherein the size of the opening defined thru the upper tether is sized to restrict the gas flow from the lower chamber to the upper chamber.

35. The driver airbag according to claim 34, wherein the size of the opening is in the range of from 10-40 square centimeters.
